(19) United States
(12) Patent Application Publication
(10) Pub. No.: US 2015/0113944 A1
(43) Pub. Date: Apr. 30, 2015

(54) THRUST REVERSER DOORS HAVING SIDE OPENINGS

(71) Applicant: AIRCELLE, Gonfreville L'orcher (FR)

(72) Inventors: Sébastien PASCAL, Epouville (FR); Laurent Albert BLIN, Sainte Adresse (FR)

(73) Assignee: AIRCELLE, Gonfreville L'orcher (FR)

(21) Appl. No.: 14/226,180

(22) Filed: Mar. 26, 2014

Related U.S. Application Data
(63) Continuation of application No. PCT/FR2012/052027, filed on Sep. 11, 2012.

(30) Foreign Application Priority Data
Sep. 29, 2011 (FR) 11/58733

(51) Int. Cl. F02K 1/68; B64D 33/04

(52) U.S. Cl. CPC F02K 1/68; B64D 33/04
USPC 60/226.2; 239/265.19

(57) ABSTRACT

A door for a door-type thrust reverser is able to move between a direct jet mode of a nacelle and a reverse jet mode. The door includes an inner wall being integrated into a flow path of an air flow generated by a turbojet engine, an outer wall, at least one side wall connecting the inner wall to the outer wall of the door, and a deflector to deflect the air flow. In particular, the deflector includes a cavity of the door which is shaped to convey a fraction of the air flow from one air inlet rigidly secured to the inner wall of the door to one air outlet rigidly secured to the side wall of the door, so as to redirect, during operation of the nacelle in the reverse jet mode, a part of the air flow upstream from the inner wall of the door.

### CROSS-REFERENCE TO RELATED APPLICATIONS

This application is a continuation of International Application No. PCT/FR2012/052027, filed on Sep. 11, 2012, which claims the benefit of FR 11/58733, filed on Sep. 29, 2011. The disclosures of the above applications are incorporated herein by reference.

### FIELD

The present disclosure relates to a door for a door-type thrust reverser as well as to such a thrust reverser and to a nacelle equipped with such a thrust reverser.

### BACKGROUND

The statements in this section merely provide background information related to the present disclosure and may not constitute prior art.

The role of a thrust reverser device during landing of an aircraft is to improve the braking ability of an aircraft by redirecting forward at least a part of the thrust generated by the turbojet engine. In this phase, the thrust reverser obstructs the gas ejection nozzle and directs the ejection flow of the engine to the front of the nacelle, thereby generating a counter-thrust which adds to the braking of the wheels of the aircraft.

The means implemented to achieve this flow redirection vary depending on the thrust reverser type. However, in all cases, the structure of a thrust reverser comprises movable cowls displaceable between, on the one hand, a deployed position in which they open a passage within the nacelle intended for the diverted flow, and on the other hand, a retracted position in which they close this passage. These movable cowls may additionally fulfill a function of deflection or simply actuation of other diverting means.

In the cascade-type thrust reversers, for example, the movable cowls slide along rails in such a way that when moving rearward during the opening phase, they uncover the cascade vanes disposed in the thickness of the nacelle. A system of rods connects this movable cowl to blocking doors which deploy within the ejection channel and block the direct flow outlet.

In the door-type thrust reversers, by contrast, each movable cowl rotates in such a way as to block the flow and divert it, and it is therefore active in this redirection.

More specifically, a door-type thrust reversal device comprises one or more doors pivotally mounted so as to be able, under the action of driving means, to switch between an inactive position called closing position during a so-called “direct jet” operation of the nacelle wherein the doors constitute a portion of the downstream section, and a reversal position or opening position wherein they switch in such a way that a downstream portion of each door comes to obstruct at least partially the nacelle duct and that an upstream portion opens, within the downstream section, a passage allowing the air flow to be radially channeled with respect to a longitudinal axis of the nacelle, during operation of the nacelle in a reverse jet mode.

The main purpose of a thrust reverser is to allow a reduction of the braking distance of an aircraft, by directing the air flow crossing the turbojet engine towards the upstream of the nacelle.

It is moreover necessary that such an air flow reversal does not damage the turbojet engine. This is particularly the case when the output cross section of air flow is too small, which causes overpressure in the nacelle, and can lead to damaging the turbojet engine.

The door(s) of the thrust reverser must therefore provide, on the one hand, a sufficient redirection of air flow so that the thrust reverser effectively fulfills its functions and, on the other hand, an exhaust of an air flow part in a sufficient amount so that the thrust reversal function does not damage the turbojet engine.

Document EP 0 558 381 is known from the state of the art, which reports drilled spoilers in order to enable the passage of a part of the air flow when the doors are open, contributing to solve the problem related to the engine damage, but having the disadvantage of efficiency loss with regard to the thrust reversal function.

Document WO 2008/142243 is also known, describing thrust reverser doors fitted with spoilers that are secured at the door head, these spoilers being pivotally mounted in a plane of the front frame around an axis substantially horizontal to the longitudinal axis of the nacelle.

Furthermore, the document EP 0 915 246 is known, which describes a door-type thrust reverser having cavities for diversion towards the top of the door.

The document EP 0 836 000 aims at increasing the rate of the crossing air flow by creating leakage regions under the doors. Another purpose of this document is to allow recovering totally or partially the created leakage in order to generate an additional counter-thrust which adds to the main counter-thrust.

The documents EP 0 368 725 and EP 0 965 744 disclose hollow doors for thrust reverser allowing to obtain an acceptable counter-thrust force and a sufficient crossing air flow rate in order not to damage the turbojet engine. However, this solution is too complex to be implemented and does not contribute to solving a recurring problem in the field of aeronautics, which is the problem of weight loss.

Finally, the device according to the document EP 2 060 766 provides spoilers arranged longitudinally on the thrust reverser door, so as to better straighten the flow and improve the counter-thrust.

Among these solutions, solutions proposed in documents WO 2008/142243 and EP 0 558 381 will be retained, which make the counter-thrust effective, and the one described in patent EP 0 836 000, which allows a passage of air flow crossing the doors, enabling to avoid the engine damage.

However, a common disadvantage to these solutions is that they address only one aspect of the issue, namely either to provide a sufficient redirection of air flow so that the thrust reverser effectively fulfills its functions or to satisfy a sufficient exhaust of air flow in order not to damage the turbojet engine.

Moreover, the devices of the prior art are complex to achieve, or inappropriate to the problem inherent to aeronautics, which is the constant search for weight reduction.

### SUMMARY

The present disclosure provides a device designed for easy integration, capable of both increasing the counter-thrust forces while not increasing the pressure inside the nacelle, in order not to damage the turbojet engine.

To this end, the present disclosure provides a door for a door-type thrust reverser able to move between a position corresponding to a direct jet-mode of a turbojet engine nacelle intended to integrate said thrust reverser, and a position corresponding to a reverse jet-mode of said nacelle, said door comprising an inner wall designed to be integrated into a flow path of an air flow generated by said turbojet engine, an outer wall designed to provide the outer aerodynamic continuity of said nacelle, at least one side wall providing the connection between said inner and outer walls of said door, and means for deflecting the air flow generated by the turbojet engine, said door being remarkable in that said deflecting means comprise a cavity of the door, said cavity being shaped so as to convey at least a fraction of said air flow from at least one air inlet rigidly secured to the inner wall of the door towards at least one air outlet rigidly secured to the side wall of the door, so as to redirect, during an operation of the nacelle in a reverse jet mode, at least a part of said air flow upstream from the inner wall of the door.

With this arrangement of the present disclosure, a part of the air flow passing through the cavities is redirected forward, that is to say towards the upstream of the nacelle, thus increasing the counter-thrust forces.

Moreover, the rate of exhaust air is increased by the air inlet created in the inner wall of the door. This makes it possible not to damage the turbojet engine during operation in a reverse jet mode.

Advantageously, the deflecting means comprise an extension of the outer wall forming a skirt extending, on the one hand, along a direction substantially parallel to the surface of the inner wall of the door according to the present disclosure and, on the other hand, beyond the side wall of said door.

Such an arrangement of deflecting means makes it possible to increase the counter-thrust forces.

Advantageously, the deflecting means are constituted by an insert, whereof one of its sides is adapted to be fixed inside the inner wall of the door according to the present disclosure and another of its sides is adapted to be fixed inside the side wall of said door.

This allows a simple and an inexpensive integration of deflecting means in the door according to the present disclosure.

According to one form of the present disclosure, the cavity is constituted by a bottom rigidly secured to the sides of the insert, said bottom being curved along a direction such that an air flow is diverted from the air inlet of the inner wall of the door towards the air outlet of the side wall of said door.

The curved bottom of the insert makes it possible to achieve deflection of a part of the air flow from the air inlet in the inner wall of the door towards the outlet in the side wall of said door.

Moreover, according to another feature of the present disclosure, the air inlets are located at the side ends of the inner wall of said door.

In still another form, the door according to the present disclosure comprises two air inlets and two air outlets.

Moreover, the air inlets and outlets are located in a lower portion of said door.

This arrangement has the advantage of enabling the air inlets to receive a large volume of air, allowing an increase in the leakage rate.

Moreover, the present disclosure also relates to a door-type thrust reverser for a turbojet engine nacelle comprising at least one door according to the present disclosure.

Finally, the present disclosure relates to a turbojet engine nacelle equipped with at least one door-type thrust reverser according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a turbojet engine nacelle operating in a reverse jet mode, equipped with a door-type thrust reverser according to the present disclosure;

FIG. 2 illustrates a front view of a door according to the present disclosure;

FIG. 3 is an enlargement of region III of FIG. 2, corresponding to an isometric centered view of the door according the present disclosure;

FIG. 4 is an isometric view also centered on the air inlet and outlet of the door according to the present disclosure, a portion of the inner wall of the door not being shown; and

FIG. 5 schematically shows the flow path of air flowing into the inner wall of a door according to the present disclosure and then deflected by the cavities.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Generally and in a well-known manner, a thrust reverser comprises at least one door adapted to be actuated by actuating means such as actuators to move from a “closed door” position corresponding to operation of the nacelle in a direct jet mode, to an “open door” position corresponding to operation of the nacelle in a reverse jet mode.

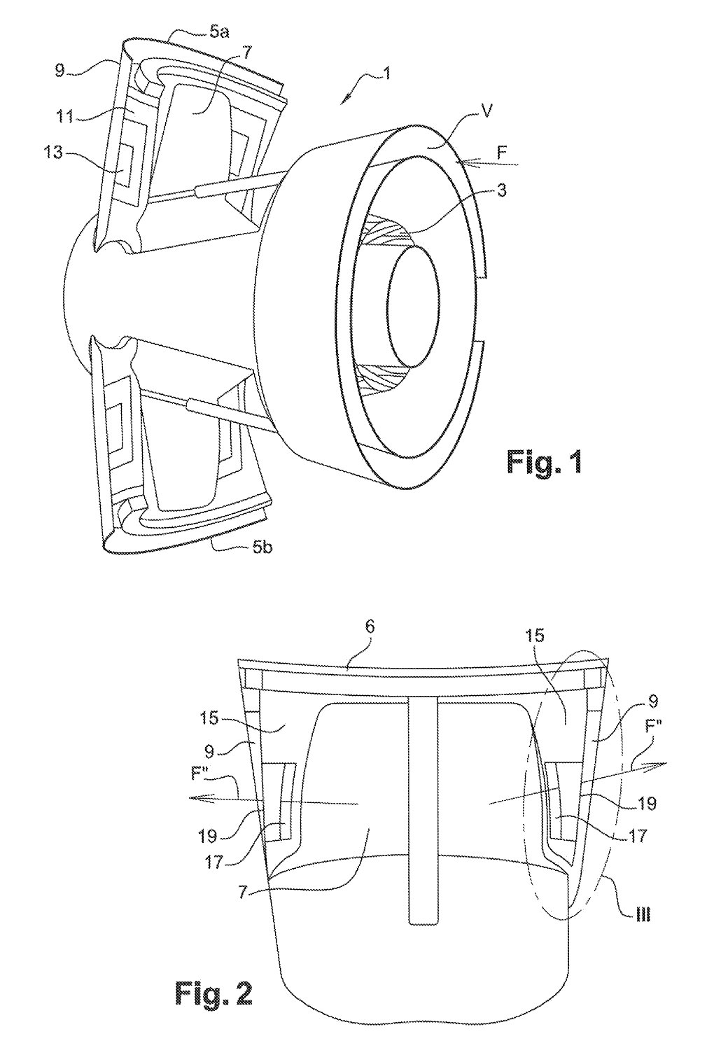

Referring to FIG. 1, illustrating a nacelle 1 for a turbojet engine 3 operating herein in a reverse jet mode, a door-type thrust reverser according to the present disclosure comprises two doors 5a, 5b according to the present disclosure.

The doors 5a and 5b being identical, one of the doors 5a or 5b is referred to as door 5 in the following description.

A door 5 according to the present disclosure is constituted by an inner wall 7 connected to an outer wall 9 by means of a side wall 11, and comprises deflecting means 13.

For a direct jet mode (not shown) of the nacelle 1, the inner wall 7 of the door 5 forms, with the inner structure 2 of a fairing of the turbojet engine 3, a flow path V intended for the circulation of a cold air flow “F” of the turbojet engine 3, also called secondary air flow.

The outer wall 9 of the door 5 is designed to provide the outer aerodynamic continuity of the nacelle 1 during a direct jet mode of the latter.

During a reverse jet mode of the nacelle 1, corresponding to a position where the doors 5 are in an open position as shown in FIG. 1, the deflecting means 13 allow deflection of the path of a part of the cold air flow “F”.

We refer to FIG. 2, illustrating a door 5 according to the present disclosure in a front view.

The door 5 comprises, in each of the side ends 15 thereof, a cutout, having a substantially rectangular shape, of a portion of the inner wall 7 of the door 5.

This cutout constitutes an air inlet 17 shaped to enable a part of the air flow “F” to enter into a defined space, in an inner portion of the door 5, that is to say between the inner wall 7, the outer wall 9, and the side wall 11 of the door 5.

Such a cutout can obviously adopt a different geometric shape adapted to enable a part of the air flow “F” to enter into the inner portion of the door 5.

Moreover, according to a feature of the present disclosure, the air inlets and outlets 17 and 19 are located in a lower portion of the door 5, that is to say, and as shown in FIG. 2, that said air inlets and outlets are located in a region of the door 5 being closer to the flow path “V” than a free edge 6 of the door 5, during a reverse jet mode of the nacelle, said free edge corresponding to the edge opposite to the one that is connected to the nacelle during a reverse jet mode of said nacelle.

Moreover, the door 5 comprises two air inlets 17 and two air outlets 19.

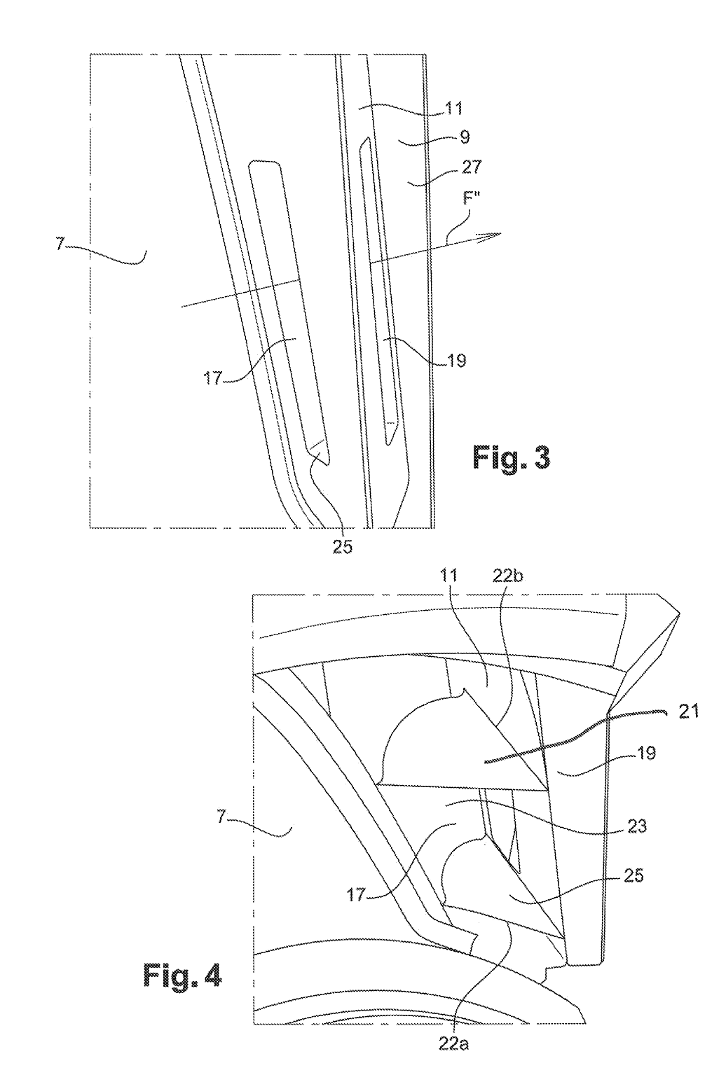

Referring now to FIG. 3, corresponding to a centered view on a side end 15 of the door 5, the inner wall 7 of the door 5 comprises an air inlet 17 as described above.

The side wall 11 of the door 5 also includes a cutout, having a substantially rectangular shape and having substantially the same dimensions as the cutout forming the air inlet 17, intended to form an air outlet 19 to allow exhaust of the air flow which has previously entered through the air inlet 17, as described below.

Such a cutout can obviously adopt a different geometric shape having the same dimensions as those of the cutout forming the air inlet 17.

We refer to FIG. 4, illustrating the door 5 according to the present disclosure, centered on the air inlet and outlet 17 and 19, on which a portion of the inner wall 7 and side wall 11 of the door is not shown.

The deflecting means 13 according to the present disclosure are constituted by a piece 21 shaped to create a passage intended to convey the air from the air inlet 17 to the air outlet 19.

The piece 21 comprises a bottom 23 of substantially rectangular and curved shape. This bottom 23 is shaped to connect a length of the cutout forming the air inlet 17 to a length of the cutout forming the air outlet 19.

The bottom 23 is covered in the widths thereof by substantially triangular shaped plates 25.

These plates 25, forming with the bottom 23 the piece 21, are necessary to prevent the air entering through the air inlet 17 from escaping in an inner portion of the door 5. The plates close the piece 21 at both ends thereof and delimit the air inlet 17 and the air outlet 19.

The piece 21 comprises two sides 22a, 22b, each side being constituted by a set of edges corresponding to the length of the bottom 23 and to one side of each triangular plate 25.

The piece 21 is intended to be attached to the door 5. A first side 22a of the piece 21 is made rigidly secured to the inside of the inner wall 7 of the door 5, and a second side 22b of the piece 21 is made rigidly secured to the inside of the side wall 11 of the door 5.

This securing can be achieved by welding, by bonding, or by any other means known by the skilled person allowing to attach one piece to another.

The piece 21 defines a cavity of the door 5, and the air inlet and outlet 17 and 19 thus communicate with each other through the curved bottom 23 of the piece 21.

Moreover, the deflecting means 13 also include a skirt 27 referred to in FIG. 3, formed by a portion of the side end of the outer wall 9.

The surface of the skirt 27 extends towards the outside of the door 5, that is to say beyond the side wall 11 of the door 5.

Moreover, said skirt 27 extends along a direction substantially parallel to the surface of the inner wall 7 of the door 5.

In one form, this skirt is formed by an extension of the outer wall 9 beyond the side wall 11 of the door 5.

In a direct jet mode of the nacelle, corresponding to a position where the doors 5 of the thrust reverser are closed, a cold air flow “F” crosses the flow path “V”.

When moving from a direct jet position to a reverse jet position of the nacelle, corresponding to a position where the doors are open, the air flow is redirected towards the upstream of the nacelle, allowing the aircraft to reduce its braking distance.

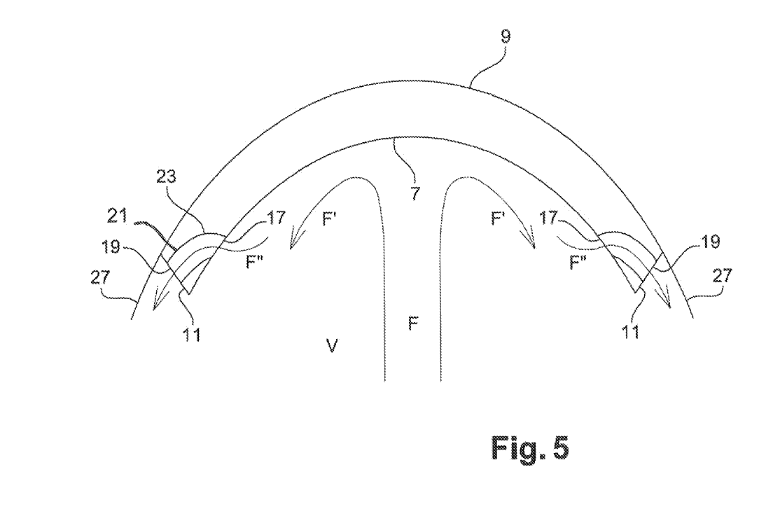

We refer now to FIG. 5 and to the description given above.

In a reverse jet mode of the nacelle, the doors 5 block the passage of the cold air flow “F” crossing the flow path “V”.

When the secondary air flow “F” flows into the flow path “V” and encounters a door 5, an air flow “F′” is created. The latter flows on the inner wall 7 of the door 5 before being redirected to the upstream of the nacelle, which has the effect of creating a counter-thrust allowing the aircraft to increase its braking forces.

As illustrated in FIG. 5, and with the features of the door 5 according to the present disclosure, an air flow “F″” derived from the air flow “F′” flowing on the inner wall 7 of the door 5 is created via the deflecting means 13.

As described above, a part of the air flow “F′” is directly redirected to the upstream of the nacelle 1 and another part “F″” enters into each air inlet 17 of the inner wall 7 of the door 5.

When the air flow “F″” passes through the cavity of the door 5, the curved bottom 23 of said insert 21 allows the air flow “F″” to press against the inner wall 7 of the door 5.

The air flow “F″” escapes then from the cavity of the door 5 through the air outlet 19 in the side wall 11 of the door 5. The air flow “F″” is therefore directed towards the upstream of the inner wall 7 of the door 5, thus increasing the counter-thrust forces.

According to one feature of the present disclosure, the skirt 27 formed by the side end of the outer wall 9 of the door 5, extending along a direction substantially parallel to the surface of the inner wall 7 of the door 5, allows the air flow “F″” to be better straightened.

Moreover, the leakage rate of the secondary air flow “F” flowing into the flow path “V” is increased thanks to the air inlets and outlets 17 and 19, which makes it possible to preserve the turbojet engine from high stresses due to significant counter-thrust forces.

Such structural features make it possible to obtain increased counter-thrust forces while allowing a significant air leakage rate.

Indeed, in the prior art, the increase of counter-thrust forces had the main disadvantage of increasing the pressure within the nacelle, and thus subjecting the turbojet engine to significant mechanical stresses that may damage its operation.

According to other issues of the prior art, the skilled person would know adjusting the air leakage rate in order not to damage the turbojet engine, but the counter-thrust forces would substantially be reduced.

With the present disclosure, a compromise is achieved between the increase of thrust forces and the sufficiency of the air leakage rate necessary to avoid damaging the turbojet engine.

Counter-thrust forces are substantially increased by means of the curved bottoms of the cavity of the door and by means of the air outlets in the side walls of the door, and the risks of damaging the turbojet engine are reduced by creating air inlets on the inner wall of the door.

Moreover, such an arrangement of a door according to the present disclosure enables an inexpensive and non-penalizing achievement with regard to the problem of weight reduction.

It goes without saying that the present disclosure is not limited to the only forms of these doors, thrust reverser fitted with these doors and nacelle integrating such a thrust reverser, described above by way of examples, but on the contrary it encompasses all the alternative forms.

What is claimed is:

1. A door for a door-type thrust reverser able to move between a position corresponding to a direct jet mode of a nacelle for a turbojet engine, and a position corresponding to a reverse jet mode of said nacelle, said door comprising:
an inner wall being integrated into a flow path of an air flow generated by said turbojet engine;
an outer wall providing an outer aerodynamic continuity of said nacelle;
at least one side wall providing a connection between said inner wall and outer wall of said door; and
means for deflecting the air flow generated by the turbojet engine,
wherein said deflecting means comprise a cavity of the door, said cavity being shaped to convey at least a fraction of said air flow from at least one air inlet rigidly secured to the inner wall of the door to at least one air outlet rigidly secured to the side wall of the door, so as to redirect, during operation of the nacelle in the reverse jet mode, at least a part of said air flow upstream from the inner wall of the door.

2. The door according to claim 1, wherein the deflecting means comprise an extension of the outer wall forming a skirt extending along a direction substantially parallel to a surface of the inner wall of the door and beyond the side wall of said door.

3. The door according to claim 1, wherein the deflecting means are constituted by an insert whereof one of sides of the insert is fixed inside the inner wall of the door and another one of the sides of the insert is fixed inside the side wall of said door.

4. The door according to claim 3, wherein the cavity is formed by a bottom rigidly secured to the sides of the insert, said bottom being curved along a direction such that an air flow is diverted from the air inlet of the inner wall of the door to the air outlet of the side wall of said door.

5. The door according to claim 1, wherein the at least one air inlet is located at side ends of the inner wall of said door.

6. The door according to claim 1, further comprising two air inlets and two air outlets.

7. The door according to claim 1, wherein the at least one air inlet and outlet are located in a lower portion of said door.

8. A door-type thrust reverser for a turbojet engine nacelle comprising at least one door according to claim 1.

9. A nacelle for a turbojet engine comprising at least one door-type thrust reverser according to claim 8.
